(19) United States
(12) Patent Application Publication
(10) Pub. No.: US 2015/0016092 A1
(43) Pub. Date: Jan. 15, 2015

(54) FRAME FOR DISPLAYING LITHOPHANES USING NATURAL DAYLIGHT OR INTEGRATED LIGHTING SYSTEM

(71) Applicant: Cole Michael Mullin, Glenfield, NY (US)

(72) Inventor: Cole Michael Mullin, Glenfield, NY (US)

(21) Appl. No.: 14/263,984

(22) Filed: Apr. 28, 2014

Related U.S. Application Data
(60) Provisional application No. 61/844,999, filed on Jul. 11, 2013.

(51) Int. Cl. F21V 33/00; F21K 99/00; F21V 23/00

(52) U.S. Cl. CPC F21V 33/0032; F21V 23/001; F21K 9/50
USPC 362/97.4

(57) ABSTRACT

A frame for displaying lithophanes that utilizes either natural daylight or electric light as the source of illumination. Current display options for lithophanes rely solely on one light source or the other, thus limiting display options. This frame will allow users to display their lithophanes whenever and wherever they like. The frame is designed with a lip to hold the lithophane to be displayed and a recess to contain the electric light source. The frame is built with an electrical connector to accept the appropriate electrical adapter. The frame utilizes a reflective rear panel to direct electric light through the lithophane for display away from a window or at night. The rear panel is removable to allow display in a window using natural daylight.

### PRIOR PROVISIONAL PATENT APPLICATION REFERENCE

This Non-Provisional Patent Application is a continuation of a previously filed Provisional Patent Application No. 61/844,999, Attorney Docket Number 506857193, filed on Jul. 11, 2013.

### BACKGROUND OF THE INVENTION

The present invention relates to displaying lithophanes and, more particularly, to frames with integrated lighting systems for displaying lithophanes.

Lithophanes cannot typically be enjoyed at night or away from windows as they are generally displayed using natural daylight. Currently, lithophane displays exclusively use natural daylight or utilize light boxes or LED panels. LED panels are costly, and light boxes are large and inconvenient to display. Both of these lighted type displays do not permit display using natural light.

As can be seen, there is a need for a device that allows lithophanes to be viewed with natural light or an integrated lighting system.

### BRIEF DESCRIPTION OF THE DRAWINGS

FIG. 1 is a rear and side view of an exemplary embodiment of the present invention; and

FIG. 2 is a cross sectional view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a frame for displaying a lithophane that may include a frame having a front side, a rear side and at least one lip; a light emitting diode (LED) light source connected to the frame along the at least one lip behind said lithophane; an electrical connector attached to the frame having an interior end and an exterior end, wherein the interior end of the electrical connector connects to the LED light source; a power cord removeably attached to the exterior end of the electrical connector; and a reflective frame back that is removeably attached to the rear side of the frame and is rear of the LED light source and electrical connector.

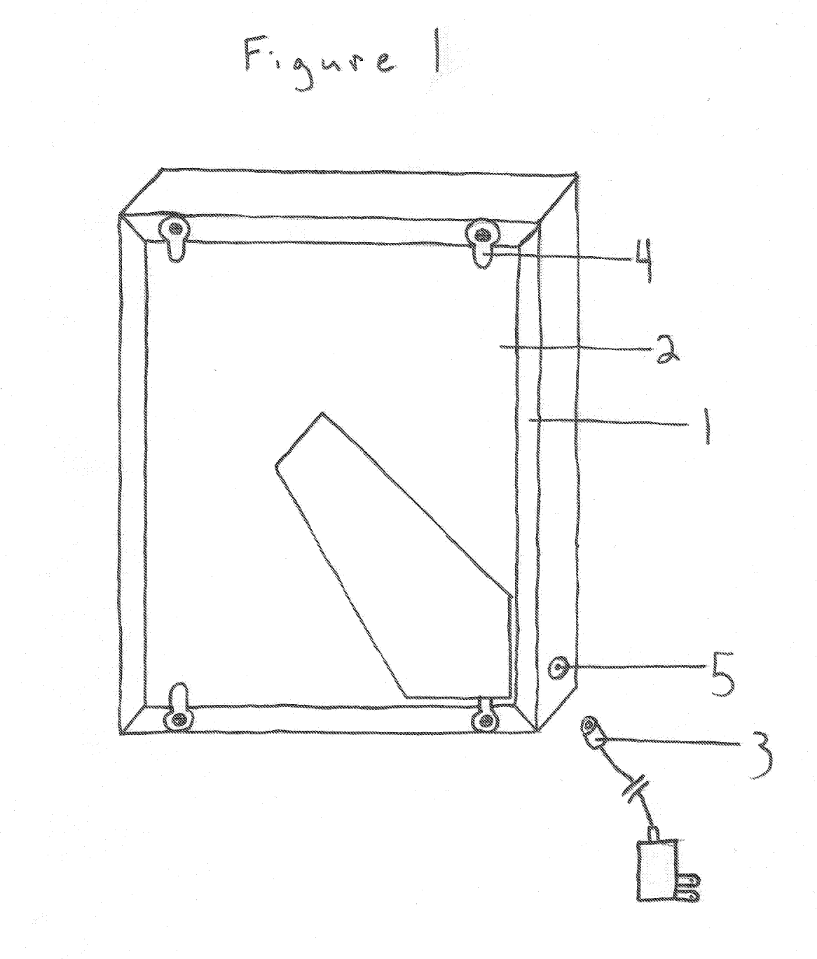

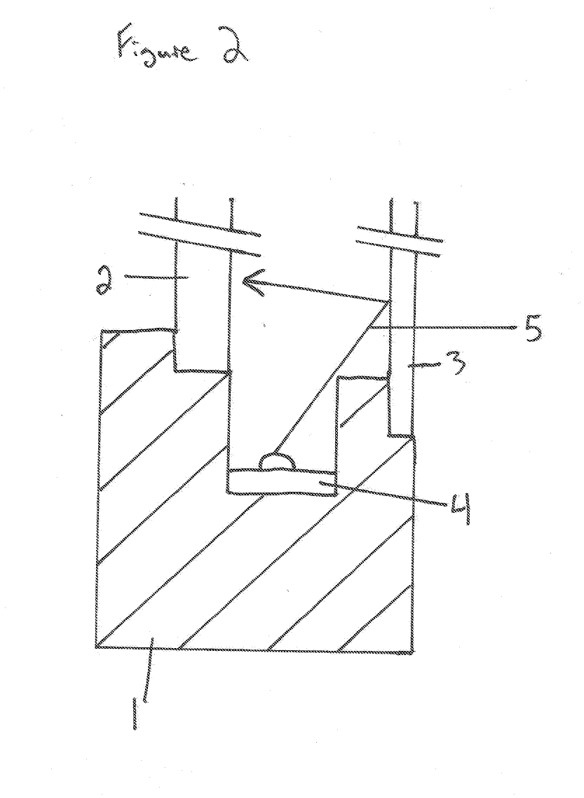

As is illustrated in FIGS. 1 and 2, an LED light source 2,4 and an electrical connector 1,5 may be installed into a frame 1,1 made of wood or a similar material that may be able to hold a lithophane. A lithophane 2,2 may be inserted into the frame 1,1. A reflective picture frame easel back 1,2 may be installed in the back of the frame 1,1. A power cord 1,3 may be used to power the LED light source.

When the power cord 1,3 may be plugged into a standard wall socket and inserted into the electrical connector 1,5 the LED light source 2,4 may be powered on, and the produced light may be directed 2,5 through the lithophane 2,2 via the removable easel back's reflective inner surface 2,3 which may be housed in the frame 1,1. The frame may be made of wood, fiberglass, plastic, carbon fiber, composite materials or the like. The reflective easel back 1,2 may be removed. When the reflective easel back 1,2 may be removed, the frame 1,1 housing the lithophane 2,2 may be displayed using natural daylight.

A lithophane may be created from a material using a CNC machine or by hand carving. The display frame may be created by cutting grooves into a wood stock with a table saw. The first cut may create a front lip to hold the lithophane in place. The second cut may create a recess to hold the LED light source. The third cut creates a lip to hold the reflective picture back. The display frame may also be created by using a router bit to cut the same necessary grooves, lips and recesses. A router may then be used to cut a profile on the frame face. The frame may then be attached together, by glue and the like. For materials such as fiberglass, plastic, carbon fiber, or composite materials and the like, a mould may be used to create the entire frame or the individual necessary components. Once assembled, a hole may be drilled into the frame to accept the electrical connector. The LED light source may be installed into the frame recess using a self adhesive backing where applicable or by using an adhesive material. The electrical connector wires may then be soldered to the LED light source. The lithophane may be secured into the frame using picture frame points or screw tabs and the like. The reflective back may then be secured in place with frame points or screw tabs and the like. The completed display frame may then be plugged into a standard wall socket to power the LED light source for indoor or evening display. The reflective back may also be removed by rotating the screw tabs or bending the frame points and the frame may then be displayed using natural daylight.

In alternate embodiments the frame may be made to various sizes to house various sized lithophanes. Different router bits may be used to create different frame face profiles. Any lithophane may be used, regardless of how it were manufactured. Any electric light source may be used, with some requiring a deeper frame. The electrical connector may be 5.5 mm. It is envisioned that the electrical connector may have various dimensions. It would simply need to connect to a power cord for use in a wall socket. The depth of the frame may be only 1.5 inches deep. It is envisioned, however, that the depth dimension may have various sizes in length.

The frame is available with a lithophane made from a user-supplied image. The user need simply plug in the frame to display their lithophane indoors or after dark. The user can then remove the reflective frame back to display their lithophane using natural daylight. In alternate embodiments, the present invention may be used to illuminate images other than lithophanes. The frame may easily be displayed on a table or a wall, and similar areas.

It should be understood, of course, that the foregoing relates to exemplary embodiments of the invention and that modifications may be made without departing from the spirit and scope of the invention as set forth in the following claims.

What is claimed is:

1. A frame for displaying a lithophane comprising:
a frame having a front side, a rear side and at least one lip;
a LED light source connected to the frame along the inside of the frame behind said lithophane;
an electrical connector attached to the frame having an interior end and an exterior end, wherein the interior end of the electrical connector connects to the LED light source.
a DC adapter removeably attached to the exterior end of the electrical connector; and
a reflective picture frame back that is removeably attached to the rear side of the frame and is rear of the LED light source and electrical connector.
